(19) United States
(12) Patent Application Publication
(10) Pub. No.: US 2013/0048413 A1
(43) Pub. Date: Feb. 28, 2013

(54) AUDIO ENHANCEMENT SYSTEM FOR A COMMUNICATION DEVICE

(71) Applicant: Charles PATZER, Columbus, OH (US)

(72) Inventor: Charles PATZER, Columbus, OH (US)

(73) Assignee: NEXT FUTURE LLC, Dublin, OH (US)

(21) Appl. No.: 13/550,528

(22) Filed: Jul. 16, 2012

Related U.S. Application Data
(60) Provisional application No. 61/526,799, filed on Aug. 24, 2011.

(51) Int. Cl. G10K 11/26

(52) U.S. Cl. 181/199

(57) ABSTRACT

A case for an communication device is provided that includes a case body adapted to be secured to communication device having at least one video output oriented in a first direction and at least one audio output oriented in a second direction substantially perpendicular to the first direction, and a sound deflector secured to the case body, the sound deflector being moveable between an extended position and a retracted position, wherein the sound deflector is configured to direct audible sound emitted from the device substantially from the second direction to the first direction when in the extended position, and wherein the sound deflector is configured to conform to a portion of the case body when in the retracted position.

### CROSS-REFERENCE TO RELATED APPLICATION

This application claims priority to U.S. Provisional Patent Application No. 61/526,799, filed Aug. 24, 2011, and entitled CELL-PHONE SOUND DEFLECTOR, which is incorporated herein by reference.

### BACKGROUND AND SUMMARY

The present disclosure is related to enhancing audio for communication devices and in particular for smart-phones and similar audio/video devices.

Communication devices, including tablet computers, smart-phones such as the Apple® i-Phone® and the Android® Droid-X®, portable media players, and other audio/video devices, often have speakers and/or microphones located in such a position as to emit or receive an audio signal in a direction different to that of an emitted video signal. For example the Apple® i-Phone® emits an audio signal from its base, at a substantially perpendicular direction from the direction the smart-phone emits the video signal from its screen. Consequently, when such an audio/video device is used to view videos, the sound emitted from the speaker is generally directed away from the listener who is viewing the video image on the device's screen. In many instances the volume and/or clarity of the audio signal is diminished and can be difficult to hear. Further, when using a smart-phone to hold a conversation when in speaker mode the user has to generally hold the microphone closer to their mouths in order to be heard by the other person. Additionally, wind noise, picked up by the microphone, makes it difficult for the speaker to be heard clearly.

A further problem arises when the device is used as a cell-phone and the microphone is oriented in a substantially different direction than the earpiece. When the user holds the cell-phone such that the earpiece is adjacent the speaker's ear, the microphone is often oriented away from the user's mouth. As a result the audio signal intercepted by the microphone may be diminished or unclear. Additionally, wind noise is more likely to have a profound effect on the quality of the audio signal intercepted by the microphone.

There is presently a need for a device which allows the user to achieve much improved volume from speakers, as well as improved voice pick-up and noise reduction for the microphone of an audio/video device. There is also a need for such a device to be light-weight, small, and portable, such as being incorporated into a protective case for the audio/video device, while still affording the user accessibility to all of the device's controls and features.

Presently disclosed is an audio enhancement system that includes a retractable sound deflector configured to be secured to a device having at least one audio output and at least one video output, the sound deflector being configured to form a curved deflector when in an extended position to redirect an audible sound from the audio output of the device to substantially align with the video output of the device, the sound deflector being configured to remain substantially flush with a surface of the device when in a retracted position.

Further disclosed is a case for an audio/video device that includes a protective case body adapted to be secured to a device having a video output oriented in a first direction and an audio output oriented in a second direction substantially perpendicular to the first direction. The case further includes a sound deflector secured to the case body, such that the sound deflector is moveable between an extended position and a retracted position. In embodiments, the sound deflector is configured to direct audible sound emitted from the device substantially from the second direction to the first direction when in the extended position, and is configured to substantially conform to a portion of the case body when in the retracted position.

Further disclosed is an audio enhancement system that includes a sound deflector securable to a device having a first audio port and a second audio port, where the first audio port lies in a first plane and the second audio port lies in a second plane at least 45 degrees offset from the first plane. In embodiments, the sound deflector is moveable between an extended position and a retracted position, and forms a curved deflector when in an extended position to redirect an audible sound to or from the first audio port to substantially align with second audio port. In embodiments, the sound deflector is sufficiently flexible to remain substantially flush with a surface of the device when in retracted position. Such an embodiment is particularly suited to a cell phone having a microphone at the base and an earpiece oriented substantially perpendicular to the orientation of the microphone. When the cell phone is positioned so that the earpiece is adjacent the speaker's ear the sound deflector may be adapted to direct the sound waves (i.e. acoustic energy) from the user's voice toward the microphone at the base of the cell phone. Such a configuration may create a fuller, richer sound for the listener.

### BRIEF DESCRIPTION OF THE DRAWINGS

Reference is made to the accompanying drawings in which particular embodiments of the invention are illustrated as described in more detail in the description below, in which:

FIG. 1 is a back perspective view of an embodiment of an audio enhancement system with a sound deflector in a retracted position.

FIG. 2 is a back perspective view of an embodiment of an audio enhancement system with a sound deflector in an extended position.

FIG. 3 is a front perspective view of another embodiment of an audio enhancement system.

FIG. 4 is an expanded view of an embodiment of an audio enhancement system.

FIG. 5 is a perspective view of another embodiment of an audio enhancement system.

FIG. 6 is a perspective view of yet another embodiment of an audio enhancement system.

FIG. 7 is a perspective view of yet another embodiment of an audio enhancement system in use.

FIG. 8 is a front perspective view of an embodiment of an audio enhancement system with the sound deflector in an extended position and the audio/video device removed.

FIG. 9 is a front perspective view of an embodiment of an audio enhancement system with the sound deflector in an extended position and the audio/video device removed.

FIG. 10 is a front perspective view of an embodiment of an audio enhancement system showing the sound deflector with the audio/video device and case body removed.

FIG. 11 is a perspective view of an embodiment of an audio enhancement system in use.

### DETAILED DESCRIPTION OF THE DRAWINGS

Presently disclosed is a system for enhancing audio performance of devices, such as tablet computers, smart-phones or other audio/video and communication devices. In various embodiments, an audio enhancement system is disclosed that includes a retractable sound deflector configured to be secured to an audio/video device. An audio/video device may have at least one audio output and at least one video output, such as is common on smart-phones, tablet computers, portable media players and other similar devices. In embodiments, The sound deflector is configured to form a curved deflector when in an extended position to redirect an audible sound emitted from an audio output of the audio/video device to substantially align with the video output of the audio/video device. The sound deflector may also be configured to remain substantially flush with a surface of the device when in retracted position. The presently disclosed audio enhancement system may be used for smart phones or other handheld devices which omit sound signals from a speaker and is particularly suited for audio/video devices having an video output oriented in a first direction and an audio output oriented in a second direction.

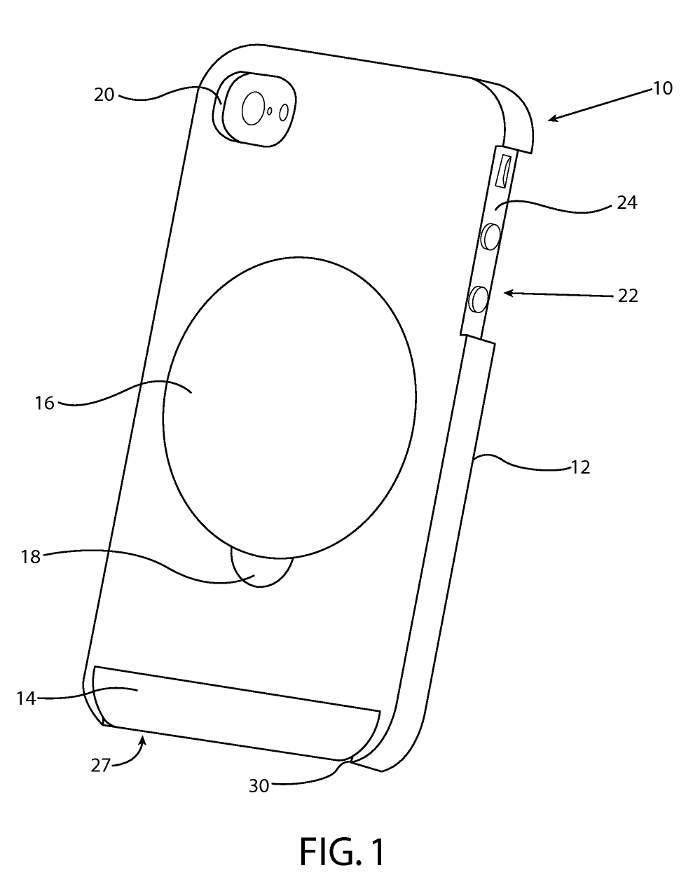

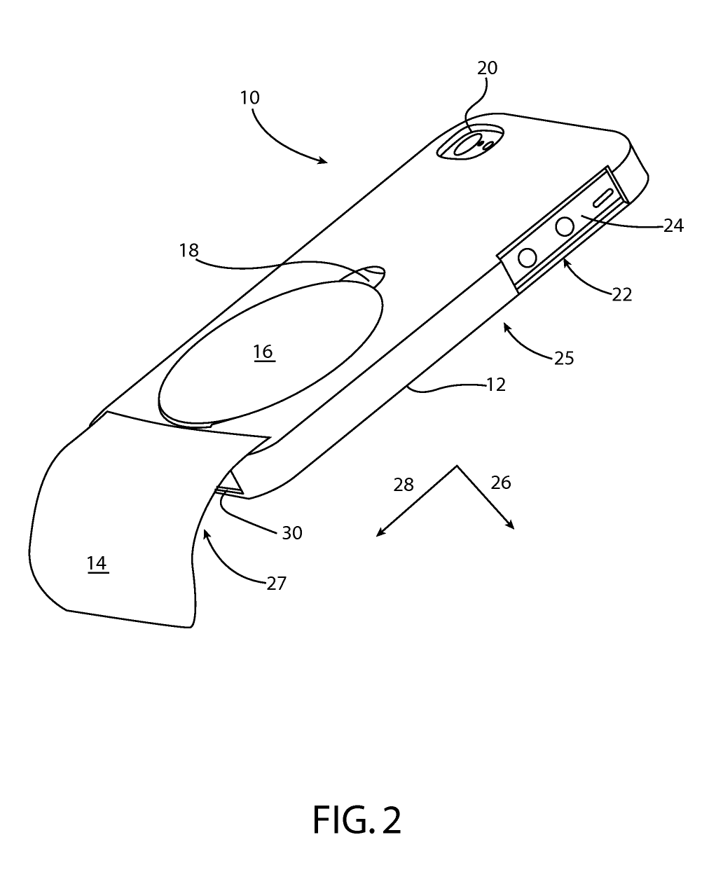

Referring generally to FIGS. 1 and 2, perspective views of the back and front of one embodiment of an audio enhancement system for use with a smart phone are illustrated. A case for an audio/video device 24 is provided that includes a case body 12 configured to be secured to a device 24 having a video output 25 oriented in a first direction 26 and an audio output 27 oriented in a second direction 28. The second direction 28 for the audio output 27 may be substantially perpendicular to the first direction 26. As illustrated, the sound deflector 14 is retractably secured to the case body 12, and the sound deflector 14 is moveable between an extended position (as shown in FIG. 2) and a retracted position (as shown in FIG. 1). The sound deflector 14 is configured to direct audible sound emitted from the audio/video device substantially in the second direction 28 (e.g. from a speaker disposed on the base of the device) to the first direction 26 (e.g. to align with a video output on the face of the device) when in the extended position. In some embodiments, the sound deflector 14 is sufficiently flexible to substantially conform to a portion of the case body 12 when in the retracted position, such as when the sound deflector is not in use. In certain embodiments, the sound deflector 14 may be disposed between the case body 12 and the device 24 when in the retracted position, but in other embodiments the sound deflector may be outside the case body or disposed in other locations. As shown in FIG. 1, the sound deflector 14 is in a retracted position and is configured to be substantially flush with a surface of the audio/video device 24.

In some embodiments, the retractable sound deflector 14 is configured to form a curved deflector when in an extended position to redirect an audible signal from the audio output 27 of the audio/video device 24. A curved deflector may transition an arc of approximately 90 degrees, such as between 60 and 120 degrees, to generally align the audible signal from the audio output 27 with a video output 25 of the device 24. In embodiments, a curved deflector includes a curved configuration such as illustrated in FIG. 2, however in other embodiments, a curved deflector may have one or more discrete transitions. As shown in FIG. 2, the audio enhancement system 10 with the sound deflector 14 in the extended position is used with an audio/video device 24 having an audio output 27 oriented in a second direction 28, and a video output 25 oriented in a first direction 26, with the first direction 26 and second direction 28 being substantially perpendicular. In other embodiments, the sound deflector 14 may be further extendable to a support position, such that the sound deflector 14 allows for the audio/video device 24 to be supported on a surface without requiring the user to hold it. Such a configuration may facilitate using the device 24 in a hand-free mode of operation, such as for watching videos or engaging in a telephone call where the device is used as a speakerphone.

Referring again to FIG. 1, a protective case 12 is adapted to house the audio/video device 24, and the retractable sound deflector 14 is secured to the protective case 12. The retractable sound deflector 14 is designed so that it does not prevent the user from using the other features of the audio/video device 24, such as a camera. As shown, a camera aperture 20 is provided in case 12 to facilitate use of the camera with the case secured to the device. The sound deflector 14 is also configured so as not to block the camera aperture 20 when the sound deflector is in the retracted position. In other embodiments, the case 12 and sound deflector 14 are configured to permit access to controls through control aperture 22. In various embodiments, the retractable sound deflector 14 may be attached to the protective case 12 by a slideable connector 16 which may include a slot 18 in the protective case 12 and a tab affixed to the retractable sound deflector 14, where the tab extends through the slot 18 to secure the sound deflector 14. The tab is slideable in the slot 18 to move the sound deflector 14 between the extended position, as shown in FIG. 2, and the retracted position, as shown in FIG. 1. When in the retracted position the sound deflector 14 may be substantially planar. The protective case 12 may further comprise an opening 30 for peripheral connections accessible when the sound deflector 14 is in the retracted position such as discussed above.

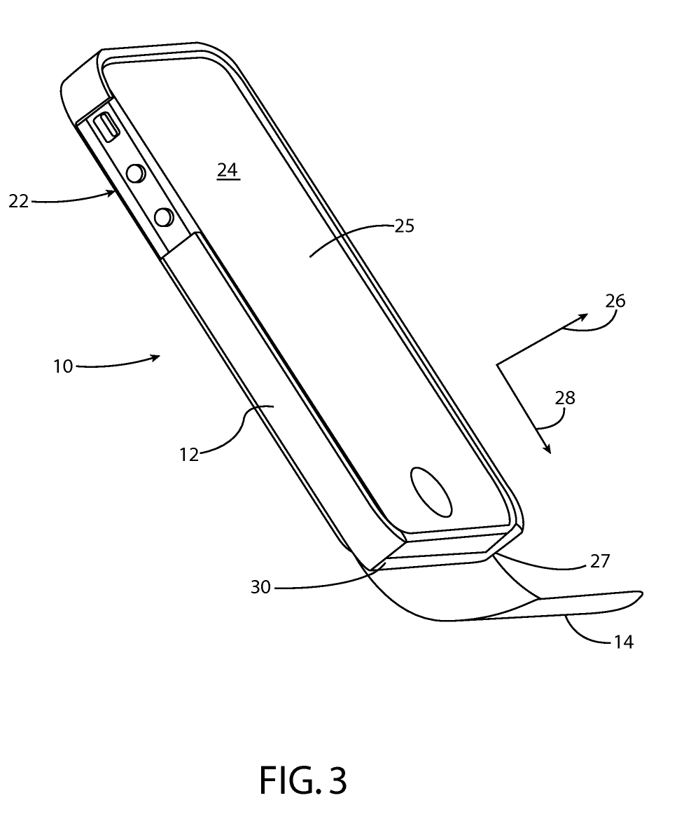

FIG. 3 shows a front perspective view of audio enhancement system 10, with the sound deflector 14 in the extended position. A video signal is emitted from the audio/video device's screen 25 in a first direction 26 and audio signal is emitted from the audio/video device's speaker 27 in a second direction 28 and is deflected by the sound deflector 14 in the extended position such as to divert the audio signal toward the first direction 26, i.e. toward the user, improving the sound quality and volume for the user.

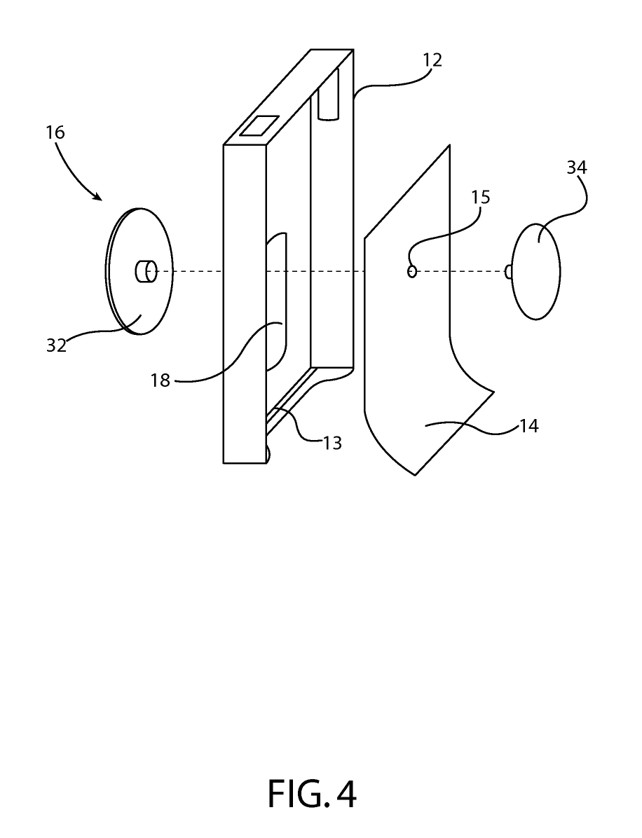

As shown in FIG. 4, the slideable connector 16 may comprise a pair of slideable components 32 and 34 on each side of the protective case 12. The slideable components 32 and 34 are operably connected such that one slideable component 32 remains on the outside face of the case 12 and the other slideable component 34 remains on the inside face of the case 12. The coupling unit of the slideable components 32 and 34 runs through the slot 18 of the case 12 and the aperture 15 of the sound deflector 14, rigidly engaging the sound deflector 14 such that the sound deflector 14 may be extended and retracted by sliding the slideable component 32 along slot 18. When assembled, the sound deflector 14 may extend and retract through the sound deflector aperture 13 in case 12, and may be disposed between the case body and the device when in the retracted position. Further, one or more latches (not shown) may be provided to releaseably retain the retractable sound deflector 14 in one or both of the retracted and extended positions.

The sound deflector 14 may be formed using sheet metal, such as a thin gauge stainless or spring steel. Spring steel may be sufficiently flexible to be retractable into a case while retaining the desired shape when in an extended position. In other embodiments, the sound deflector 14 may be formed of injection or extrusion molded plastic, or a thermal-set plastic. In yet other embodiments, the retractable sound deflector may be formed of thermal-set elastomers such as silicone, polyisoprene, latex, neoprene, or other thermal-set material. In another embodiment, the sound deflector may be formed of thermoplastic elastomers such as Santoprene, Pebax, Kraton, or various compositions of polyurethane. In still other embodiments, the sound deflector may be formed of a thermoplastic polymer such as very thin polycarbonate (PC), acrylic, polyvinyl chloride (PVC), polypropylene (PP), or polyethelyene (PE). Additionally, the sound deflector may comprise one or more of the foregoing or similar materials, and may include combinations of materials to achieve the degree of flexibility and resiliency desired for a given application.

The audio enhancement system may be manufactured using a variety of techniques depending upon the materials selected for the protective case and/or the sound deflector. In one embodiment, the protective case may be injected molded from one or more plastic materials. Similarly, the sound deflector may be injection molded, or compression or injection/compression manufacturing methods may be used according to the material properties. In one embodiment, a sound deflector formed of a silicone material may be formed by liquid injection molding.

In various embodiments, the protective case 12 may be formed of the same or different materials as the sound deflector 14. In one embodiment, the protective case may comprise a stamped metal, such as aluminum providing a rugged protective covering for the audio/video device. In other embodiments, the protective case may comprise a laminate, such as carbon fiber, Kevlar, or graphite. In yet other embodiments, the protective case may comprise a thermoplastic, such as polycarbonate, acrylic, PVC, or nylon. A thermoplastic used for the protective case may be the same or different than a thermoplastic used for the sound deflector. In the many embodiments the material for the sound deflector 14 and the case 12 will be inexpensive, durable and easy to clean.

In a further embodiment, an audio enhancement system 10 is provided that includes a sound deflector 14 configured to be secured to a device 24 having a first audio port and a second audio port, where the first audio port lies in a first plane and the second audio port lies in a second plane at least 45 degrees offset from the first plane. The sound deflector is configured to be moved between an extended position and a retracted position, such that the sound deflector 14 forms a curved deflector when in the extended position to redirect an audible sound to or from the first audio port to substantially align with the second audio port, and such that the sound deflector 14 is sufficiently flexible to remain substantially flush with a surface of the device 24 when in the retracted position.

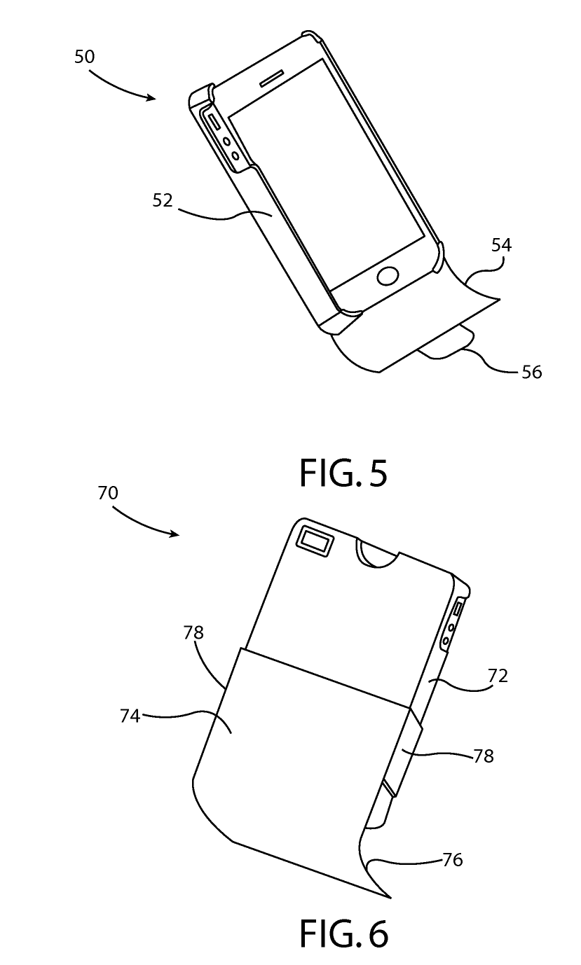

Referring to FIG. 5, another embodiment of an audio enhancement system 50 is illustrated. The audio enhancement system 50 includes a protective case 52 with a case body adapted to be secured to an audio or audio/video device, such as a smart phone, as previously described. The audio enhancement system further includes a sound deflector 54 secured to the protective case that is moveable between a retracted position and the extended position. As shown in FIG. 5, the sound deflector 54 further includes a tab 56 extending from the sound deflector 54. In one embodiment, the tab 56 is provided to facilitate movement of the sound deflector from the retracted position to the extended position. The tab 56 may be securely affixed to the sound deflector 54, or may be integrally formed with the sound deflector. When the sound deflector is in a retracted position, the tab 56 may be accessible to a user allowing the user to grip the tab and move the sound deflector from the retracted position to the extended position. Additionally, the tab may be sufficiently rigid to permit a user to push or pull on the tab 56 to cause the sound deflector 54 to move from the extended position to the retracted position. In some embodiments, the sound deflector may slideably engage the protective case without the need for a separate slideable connector. In other embodiments, both a tab and a slideable connector may be provided to allow the user greater flexibility in use of the audio enhancement device.

Referring to FIG. 6, yet another embodiment of an audio enhancement device 70 is illustrated. As shown in FIG. 6, the audio enhancement device 70 includes a case body that includes an upper portion 72 and a lower portion 74. The upper portion and the lower portion of the case body may be connected in a slideable arrangement, such that the lower portion of the case body may be extended to form a sound deflector 76. In this manner, the audio enhancement device 70 may be constructed such that a portion of the case body serves as a protective casing for the audio/video device and, in addition, serves as the retractable sound deflector. In one embodiment, the lower portion of the case body is secured by a slideable connector to the upper portion of the case body and configured to extend into the desired shape as a sound deflector to direct audible sound emitted from a device in the desired direction. As shown in FIG. 6, the lower portion 74 includes side portions 78 that engage corresponding side portions of the upper portion 72. In one embodiment, the side portions 78 of the lower portion 74 extend outside the upper portion 72 as illustrated. In one embodiment, the side portions 78 may have a lip that interlocks with the corresponding side portions of the upper portion 72, with the side portion of the upper portion 72 acting as a rail. In another embodiment, side portions of the upper portion 72 may have a lip that correspondingly interlocks with the side portions 78 of the lower portion 74, with the side portions 78 acting as rails. A lip of the side portions of the upper portion or the lower portion may have a profile that is substantially L-shaped, U-shaped, or otherwise geometrically shaped. In yet another embodiment, the side portions of the upper portion 72 have a stop that engages the side portions 78 of the lower portion 74 to limit the range of motion for the lower portion 74. In yet another embodiment, the side portions 78 of the lower portion 74 may extend inside the upper portion 72 through one or more slots in the upper portion 72. In yet another embodiment, the upper and lower portions of the case body may be connected by an accordion connection allowing the lower portion of the case body to be extended while maintaining a protective covering for the device.

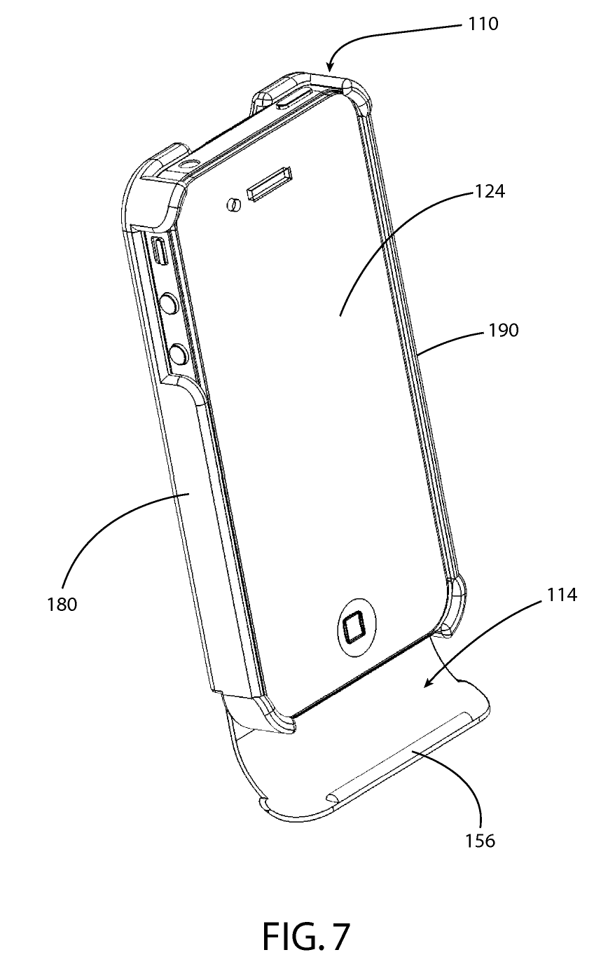

Referring now to FIGS. 7-11, another embodiment of an audio enhancement system is disclosed in use with a case for an audio/visual device.

An audio enhancement system 110 is illustrated in FIG. 7 in use with an audio/video device 124. As illustrated, the audio enhancement system 110 includes a sound deflector 114, first side wall 180, and a second sidewall 190. In various embodiments, the first side wall 180 and the second side wall 190 assist in securing the audio enhancement system to the audio/video device 124. The audio/video device 124 has at least one video output oriented in a first direction and at least one audio output oriented in a second direction substantially perpendicular to the first direction, such as the illustrated smart phone. The sound deflector 114 is secured to the case body and is moveable between an extended position and a retracted position. The sound deflector 114 is configured to direct audible sound emitted from the audio/visual device 124 from the second direction to the first direction when in the extended position. In an embodiment, the sound deflector 114 includes a ridge 156 extending from the sound deflector 114. The ridge 156 may be provided to facilitate movement of the sound deflector between a retracted position and an extended position. The ridge 156 may be securely affixed to the sound deflector 114, or it may be integrally formed with the sound deflector. When the sound deflector is in a retracted position, the ridge 156 may be accessible to a user allowing the user to grip the ridge 156 and move the sound deflector from the retracted position to the extended position. Additionally, the ridge may be sufficiently rigid to permit a user to push or pull on the ridge 156 to cause the sound deflector 114 to move from the extended position to the retracted position.

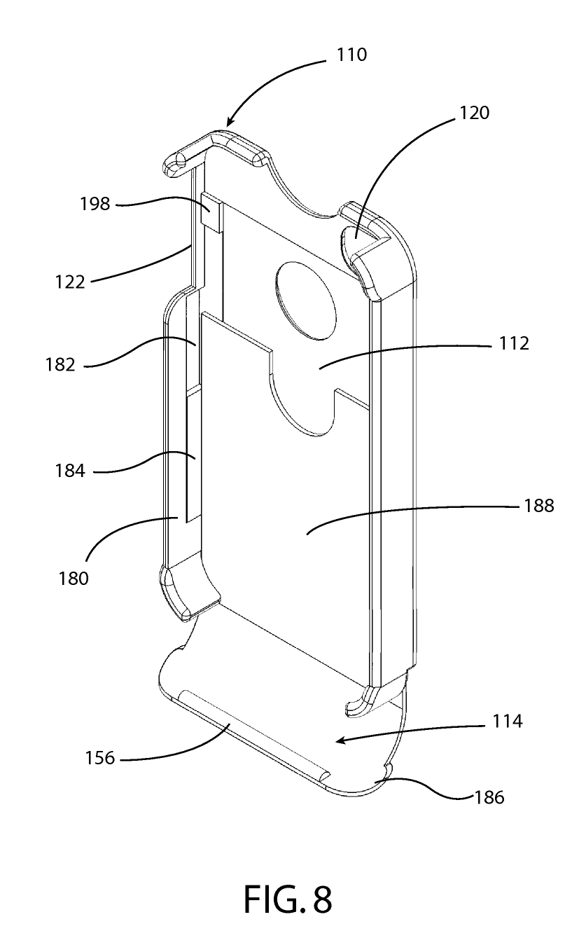

Referring now to FIG. 8, the audio enhancement system 110 is illustrated with the audio/video device removed. A protective case body 112, which includes first side wall 180 and second side wall 190, is adapted to house an audio/video device. As shown, the sound deflector 114 is configured to conform to a portion of the case body 112 when in the retracted position. A camera aperture 120 may be provided in the case body 112 to facilitate use of a device's camera with the case secured to the device. The sound deflector 114 may also be configured so as not to block the camera aperture 120 when the sound deflector is in the retracted position. To facilitate operation of the device, the case body 112 and the sound deflector 114 are also configured to permit access to the device controls through a control aperture 122. The case body 112 may also have openings for peripheral connections which are still accessible when the sound deflector 114 is in the retracted position. Depending upon the location of the peripheral connections on the device, the peripheral connections may also be accessible when the sound deflector 114 is in the extended position as illustrated.

The sound deflector 114 may also include components to facilitate position or movement of the sound deflector. As previously discussed, the sound deflector 114 may include a ridge 156. In embodiments, the sound deflector may also include at least one stop 186. While the ridge 156 may facilitate movement of the sound deflector between the retracted position and the extended position, the sound deflector stop 186 limits movement of the sound deflector 114, for example, by preventing the sound deflector 114 from being retracted so that the ridge 156 is inaccessible to the user with the case installed on an audio/visual device. The sound deflector stop 186 may also assist the user in extending the sound deflector, with or without use of the ridge 156. The sound deflector stop 186 may also prevent the retracted sound deflector from obstructing the control aperture 122 or the camera aperture 120.

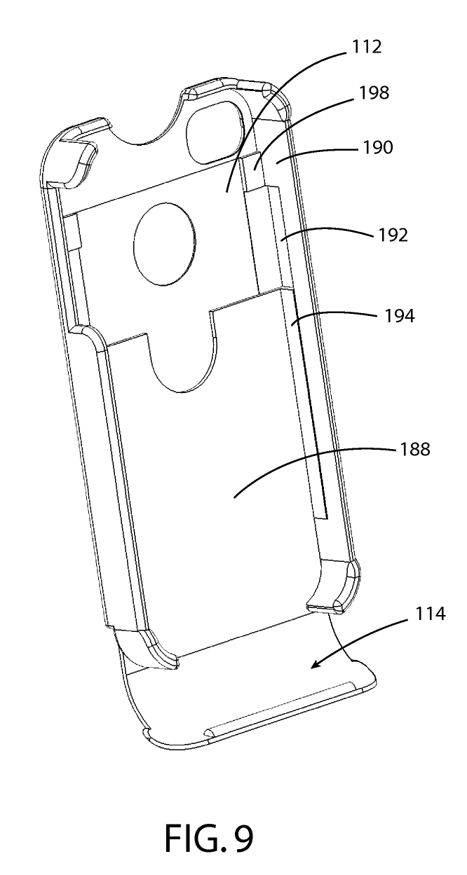

In embodiments, the case body 112 includes a standoff 198 (shown in FIGS. 8 and 9). The standoff 198 is disposed between the back of the audio/video device and a portion of the case body 112 to maintain a clearance between the case body and the audio/video device. The clearance is sized to accommodate the sound deflector between the audio/video device and the case body. In an embodiment, the standoff 198 has a thickness that is equal to the thickness of the sound deflector. In other embodiments, the standoff 198 may be thinner than the sound deflector such that the sound deflector maintains an interference fit between the audio/video device and the case body. In yet other embodiments, the standoff 198 is thicker than the sound deflector such that the sound deflector may be retracted and extended without contacting the back portion of the audio/video device. In some embodiments, the standoff 198 may also be used to limit movement of the sound deflector to prevent over retraction of the sound deflector into the case body. The standoff 198 may be positioned to provide a mechanical stop that prevents further retraction of the sound deflector. For example, the retraction of the sound deflector may be restricted to avoid obstructing the control aperture 122, or other apertures in the case body. In yet other embodiments, the standoff 198 may be positioned such that the sound deflector 114 may be frictionally retained between the standoff and the back of the audio/video device to secure the sound deflector in the retracted position. In yet another embodiment, the sound deflector 114 may be retained in the retracted position or the extended position by a releasable latch.

The sound deflector 114 further includes a slideable portion 188. The slideable portion 188 fits within the case body 112, resulting in the slideable portion being disposed between the case body 112 and the audio/visual device when the sound deflector is in the retracted position. When retracted, the sound deflector 114 is substantially planar. The sound deflector 114 has a first protrusion 184 that engages a recess 182 of the first sidewall 180 of the case body 112 to retractably secure the sound deflector to the case body by way of a slideable connection. A recess 182 may be on one or a combination of the interior, exterior, or top surface of the first sidewall 180, where the interior surface faces the audio/visual device, the exterior surface faces away from the audio/visual device, and the top surface extends between the interior and exterior surfaces. The first protrusion 184 may be sized to prevent blocking user access to the audio/visual device through the control aperture 122.

Referring now to FIG. 9, a second protrusion 194 of the slideable portion 188 of the sound deflector 114 is illustrated opposite the first protrusion (not shown in FIG. 9). The second protrusion 194 engages a recess 192 of the second sidewall 190 of the case body 112 to retractably secure the sound deflector to the case body by way of a slideable connection. Similar to recess 182, the recess 192 may be on one or a combination of an interior, exterior, or top surface of the second sidewall 190.

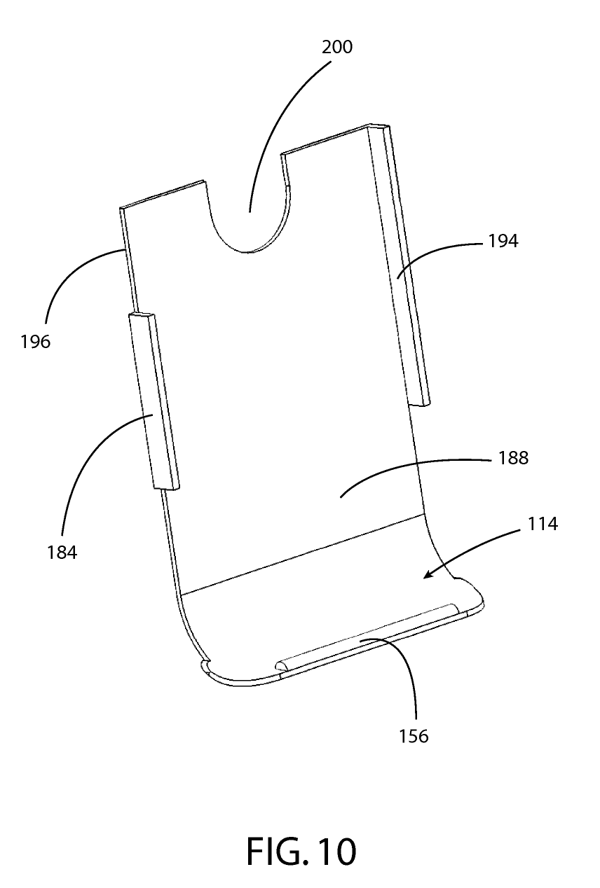

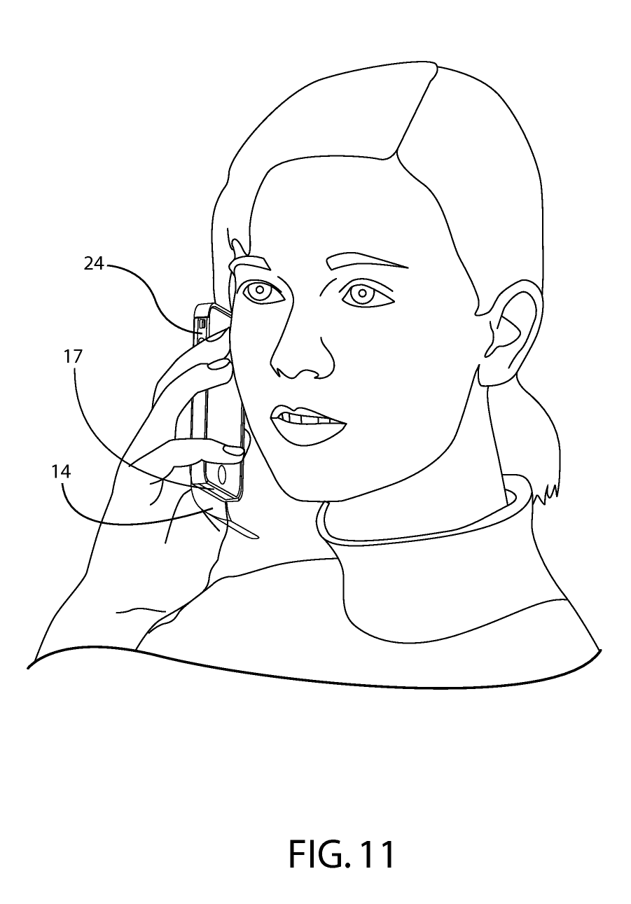

To further illustrate an embodiment of the sound deflector 114, FIG. 10 shows the sound deflector 114 removed from the case body revealing the slideable portion 188 having the first protrusion 184 and the second protrusion 194. The sound deflector 114 also includes an aperture 200, which may correspond to a camera aperture of a case body. The aperture 200 and camera aperture of a case body may be located in any location so as to avoid obscuring the field of view of a camera in the audio/video device with which the case is to be used. As illustrated, the first protrusion 184 and second protrusion 194 may be of different sizes. In the embodiment illustrated, a control notch 196 is provided by the shorter first protrusion allowing access to the control buttons of the device. In this manner, the first and second protrusions may be adapted to both provide adequate engagement of the sound deflector with the case body, while maintaining sufficient clearance so that the controls, camera or other features of the audio/video device are not obscured. In yet another embodiment, the aperture 200 and corresponding aperture in a case body are positioned to reveal a logo or other brand identifier of the device.

Referring now to FIG. 11, an audio enhancement system is illustrated in use where the audio/video device 24 is a cell phone such as a smart phone, and is positioned such that the cell-phone's earpiece (not shown) is adjacent the speaker's ear. In this configuration, the audio output of the phone (e.g. the speaker directed towards the user's ear) is oriented in first direction. In contrast, the microphone of the phone is oriented in a second direction from the base or bottom portion of the phone and may be misaligned with the users mouth and may have difficulty capturing the user's voice. As shown, the retractable sound deflector 14 may be configured to direct the sound waves from the user's voice to the microphone 17 in the base of the device. In such an embodiment the listener benefits from increased clarity and volume from the speaker, and further, the sound deflector 14 acts as a wind-break, reducing wind noise which tends to interfere with the quality of the audio signal being transmitted from the microphone to the listener.

In yet a further embodiment, the audio/video device 24 has two speakers emitting sound in different directions, and the sound deflector 14 is adapted such that the audio signal from one or both speakers is deflected to divert the audio signals toward the same direction, resulting in a fuller, richer sound for the listener.

Referring now to FIGS. 8 through 11, several view of another embodiment of an audio enhancement device are shown. FIG. 8 shows a back perspective view of the audio enhancement system with the sound deflector in the extended position. FIG. 9 shows a front perspective view of the audio enhancement system with the sound deflector in the extended position. FIG. 10 shows a back perspective view of the audio enhancement system with the sound deflector in the retracted position. FIG. 11 shows a front perspective view of the audio enhancement system with the sound deflector in the retracted position.

In the specification and claims, reference will be made to a number of terms have the following meanings. The singular forms “a”, “an” and “the” include plural referents unless the context clearly dictates otherwise. Approximating language, as used herein throughout the specification and clauses, may be applied to modify any quantitative representation that could permissibly vary without resulting in a change in the basic function to which it is related. Accordingly, a value modified by a term such as “about” or “substantially” is not to be limited to a precise value. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

While certain embodiments have been described, it must be understood that various changes may be made and equivalents may be substituted without departing from the spirit or scope of the present disclosure. In addition, many modifications may be made to adapt a particular situation or material to the teachings of the disclosure without departing from its spirit or scope.

What is claimed is:

1. An audio enhancement system comprising:
a retractable sound deflector configured to be secured to a device having an audio output and a video output, wherein the retractable sound defector is movable between an extended position and a retracted position; and
wherein the sound deflector is configured to form a curved deflector when in the extended position to redirect an audible sound from the audio output of the device to substantially align with the video output of the device, and
wherein the sound deflector is configured to remain substantially flush with a surface of the device when in a retracted position

2. The audio enhancement system as claimed in claim 1, wherein the retractable sound deflector comprises a sheet metal, an injection or extrusion molded plastic, or a thermal-set material.

3. The audio enhancement system as claimed in claim 1, wherein the device is a smart phone with the video output oriented in a first direction and the audio output oriented in a second direction substantially perpendicular to the first direction, and wherein the retractable sound defector is configured to redirect the audible sound from the audio output to substantially align with the first direction.

4. The audio enhancement system as claimed in claim 1 further comprising:
a protective case adapted to house the device, wherein the retractable sound deflector is secured to the protective case.

5. The audio enhancement system as claimed in claim 4 further comprising:
a slideable connector configured to secure the retractable sound deflector to the protective case.

6. The audio enhancement system as claimed in claim 5, wherein the slideable connector comprises a slot in the protective case and a tab affixed to the retractable sound deflector, wherein the tab extends through the slot to secure the retractable sound deflector to the protective case, and wherein the tab is slideable in the slot to move the sound deflector between the extended position and the retracted position.

7. The audio enhancement system as claimed in claim 5, wherein the slideable connector comprises a pair of slideable components on each side of the protective case.

8. The audio enhancement system as claimed in claim 1, wherein the retractable sound deflector is further extendable to a support position for supporting the device on a surface.

9. The audio enhancement system as claimed in claim 1 further comprising:
a latch adapted to releaseably retain the retractable sound deflector in the retracted position.

10. The audio enhancement system as claimed in claim 1 further comprising:
a latch adapted to releaseably retain the retractable sound deflector in the extended position.

11. A case for an audio/video device comprising
a case body adapted to be secured to an audio/video device having at least one video output oriented in a first direction and at least one audio output oriented in a second direction substantially perpendicular to the first direction, and
a sound deflector secured to the case body, the sound deflector being moveable between an extended position and a retracted position,
wherein the sound deflector is configured to direct audible sound emitted from the audio/video device substantially from the second direction to the first direction when in the extended position, and
wherein the sound deflector is configured to conform to a portion of the case body when in the retracted position.

12. The case for an audio/video device as claimed in claim 11, wherein the sound defector comprises at least one protrusion and the case body comprises at least one recess adapted to receive the at least one protrusion of the sound defector to retractably secure the sound deflector to the case body.

13. The case for an audio/video device as claimed in claim 12, wherein the at least one recess of the case body is disposed on an interior surface of a side wall of the case body.

14. The case for an audio/video device as claimed in claim 11, wherein the sound defector comprises two protrusions extending from a side portion of the sound deflector and wherein the case body includes two recesses, wherein each of the two recesses of the case body is adapted to receive one of the two protrusions of the sound deflector to retractably secure the sound deflector to the case body.

15. The case for an audio/video device as claimed in claim 11, wherein at least a portion of the sound deflector is disposed between the case body and the audio/video device when the sound deflector is in the retracted position.

16. The case body for an audio/video device as claimed in claim 11, wherein the sound defector further comprises a gripping portion that is accessible to a user when the sound defector is in the retracted position.

17. The case for an audio/video device as claimed in claim 11, wherein the sound deflector comprises a sheet metal, an injection or extrusion molded plastic, or a thermal-set material.

18. The case for an audio/video device as claimed in claim 11, wherein the audio/video device is a smart phone.

19. The case for an audio/video device as claimed in claim 11, wherein the audio/video device is a tablet computer.

20. The case for an audio/video device as claimed in claim 11, wherein the audio/video device is a portable media player.

21. The case for an audio/video device as claimed in claim 11, wherein the sound deflector is secured to the case body by a slideable connector.

22. The case for an audio/video device as claimed in claim 11, wherein the case body further comprises an opening for at least one peripheral connection, wherein the opening is accessible when the sound deflector is in the retracted position.

23. The case for an audio/video device as claimed in claim 11, wherein the sound deflector is substantially planar when in the retracted position.

24. The case for an audio/video device as claimed in claim 11 further comprising:
a latch adapted to releaseably retain the sound deflector in the retracted position.

25. The case for an audio/video device as claimed in claim 11 further comprising:
a latch adapted to releaseably retain the sound deflector in the extended position.

26. An audio enhancement system comprising:
a sound deflector securable to a device having a first audio port and a second audio port, where the first audio port lies in a first plane and the second audio port lies in a second plane at least 45 degrees offset from the first plane, the sound deflector being moveable between an extended position and a retracted position,
wherein the sound deflector is adapted to form a curved deflector when in the extended position to redirect an audible sound to or from the first audio port to substantially align with second audio port, and
wherein the sound deflector is sufficiently flexible to remain substantially flush with a surface of the device when in retracted position.

27. A case for an audio/video device, the case comprising
a case body adapted to be secured to a communication device having at least one video output oriented in a first direction and at least one audio output oriented in a second direction substantially perpendicular to the first direction, and
means for directing an audible sound emitted from the audio output in the second direction to substantially align with an output of the video output in the first direction.
